(19) United States
(12) Patent Application Publication
(10) Pub. No.: US 2006/0231215 A1
(43) Pub. Date: Oct. 19, 2006

(54) Roller shutters

(76) Inventor: Paul Van De Loo, South Australia (AU)

Correspondence Address: F. CHAU & ASSOCIATES, LLC, 130 WOODBURY ROAD, WOODBURY, NY, 11797, US

(21) Appl. No.: 10/514,273

(22) PCT Filed: May 13, 2003
(86) PCT No.: PCT/AU03/00576

§ 371 Date: Apr. 10, 2006

(30) Foreign Application Priority Data
May 13, 2002 (AU) PS 2249

(51) Int. Cl. E06B 9/08

(52) U.S. Cl. 160/133

(57) ABSTRACT

A portable power supply assembly (24) capable of providing electrical power to an electric motor of a flexible shutter assembly (13) and a torsion spring assembly (21) capable of reducing load on the electric motor of a shutter assembly. The portable power supply assembly includes a portable supply of power (26), a detachable body (24) capable of electrically connecting the portable supply of power (26) to the receiving port(25) and a means of controlling the portable supply of power (29). The torsion spring assembly (21) includes a housing (57, 58) able to be mounted at or towards one end of the shaft; a torsion spring (56) mounted within the housing, one end (63) of the torsion spring being held with respect to the housing (57, 58) and a shaft adapter (64) rotatably mounted with respect to the housing, the other end (67) of the torsion spring being held with respect to the shaft adapter.

### FIELD OF THE INVENTION

The present invention relates to shutter assemblies of the type often referred to as “roller shutters” or “roller doors”, which have a flexible shutter that is able to be raised and lowered by being wound onto and off a rotating shaft.

The shutter is typically configured to be able to close off a window or a door or another similar opening, although it will be appreciated that the shutter may also be used in situations where there is no obvious opening such as when the shutter is simply being used to form a barrier or shelter or the like.

### BACKGROUND OF THE INVENTION

Typical shutter assemblies normally comprise a plurality of elongate adjacent segments or slats that are connected along adjacent edges by some type of hinging. Thus, the shutter is flexible in that it may be wound onto and off a rotating shaft, the shaft normally being mounted above an opening within an enclosure such as a head box.

By providing suitable vertical guide rails about the side peripheries of the opening, each guide rail being capable of slidably receiving guiding abutments at the ends of each hinge, the shutter can be constrained in a planar (and usually vertical) configuration to close off the opening when wound off the shaft.

The operation of such shutter assemblies has typically been achieved manually, via a hand crank mechanism that rotates the shaft, or electrically via a motor (with associated gearing) mounted within the shaft. In this latter form, the shaft is usually mounted for rotation by the motor, within the head box, via bearings at either end thereof.

The present invention aims to provide improvements to these typical shutter assemblies.

### STATEMENT OF THE INVENTION

The present invention provides a portable power supply assembly capable of providing electrical power to an electric motor of a shutter assembly, the shutter assembly including a flexible shutter able to open and clos by being wound onto and off a rotating shaft, and an electrical power receiving port electrically connected to the electric motor, wherein the portable power supply assembly includes:

(a) a portable supply of power;

(b) a detachable body capable of electrically connecting the portable supply of power to the receiving port; and

(c) a means for controlling the portable supply of power to operate the shutter assembly when the detachable body is connected to the receiving port.

The present invention also provides a shutter assembly having a portable power supply assembly, the shutter assembly including an electric motor, an electrical power receiving port electrically connected to the electric motor, and a flexible shutter able to open and close by being wound onto and off a rotating shaft, the portable power supply assembly including:

(a) a portable supply of power;

(b) a detachable body capable of electrically connecting the portable supply of power to the receiving port; and

(c) a means for controlling the portable supply of power to operate the shutter assembly when the detachable body is connected to the receiving port.

The present invention further provides a series of shutter assemblies and a single portable power supply assembly, each shutter assembly including an electric motor, an electrical power receiving port electrically connected to the electric motor, and a flexible shutter able to open and close by being wound onto and off a rotating shaft, the single portable power supply assembly including:

(a) a portable supply of power;

(b) a detachable body capable of electrically connecting the portable supply of power to any of the receiving ports;

(c) a means for controlling the portable supply of power to operate a shutter assembly when the detachable body is connected to the receiving port of that shutter assembly.

In these broad forms of the invention, there is reference to the provision of ‘electrical power to an electric motor’, to the electrical power receiving port being ‘electrically connected to the electric motor’, and to the detachable body ‘electrically connecting the portable supply of power to a receiving port’. It should be appreciated that these references include either direct or indirect electrical connections. For instance, the provision of electrical power to the electric motor may be attended to by the provision of power to an electric drive unit that itself contains one or more electric motors together with suitable gearing, likely contained in a gear-box of some type. Similarly, the electrical power receiving port may be connected directly to the electric motor (or, as mentioned, a suitable electric drive unit), or may be connected indirectly, such as via other components or circuitry.

In a preferred form, the electrical power receiving port of the shutter assembly is provided near or adjacent the shutter itself, either inside or outside the building. The port must of course be accessible by a user and would ordinarily be in the form of a wall-mounted plate or bracket. In a preferred form, the port will be a wall-mounted plate electrically connected to the electrical motor of the shutter assembly, such as by being connected directly to the electric motor.

In this form, the plate will preferably be adapted so as to both mechanically and electrically receive the detachable body of the portable power supply assembly. Mechanical reception may be provided by any suitable means, such as by interacting snap-fit attachments or by suitable plug and socket components. Mechanical locks may also be utilized in order to permit the portable power supply assembly to be semi-permanently located with the plate.

In relation to the electrical connection of the detachable body of the portable power supply assembly to the receiving port, again any suitable form of electrical connection may be provided. For example, the receiving port may contain a series of conductive pins, which engage conductive receptors in the portable power supply, by virtue of either sliding or point contact.

The detachable body itself may be of any suitable general configuration. For example, the body may be a simple box-like shape, of a size that assists with handheld operation, and with an outwardly accessible controlling means.

In another form, the body may include a handle portion integral with a separate body portion. With this in mind, the controlling means of the portable power supply assembly may then be provided by a suitable switching means such as by a type of trigger (or simply as a normal electrical switch) as a part of the handle portion. Ideally, the detachable body will be of a size that lends itself to easy operation by hand.

The controlling means may also be of any suitable type, and ideally will be a switching means of some type. In this respect, reference to the controlling means ‘controlling the portable supply of power to operate the shutter assembly’ should be interpreted broadly to cover situations where the controlling means has direct or indirect control over the power supply, or direct or indirect control over other components or circuitry associated with the power supply, the electric motor or perhaps with electronics that may be associated with an electrical drive unit that contains the electric motor, such as via a traditional electronic controller.

For instance, the switching means may be such as to normally permit the selection of any of a desired number of shutter states, such as up, down or off, and may be such as a toggle switch or a momentary contact switch that may have two, three or more toggles or buttons as necessary.

In relation to the portable supply of power utilized by each portable power supply assembly, it will be appreciated that the normal types of portable power supply may be utilized, such as batteries, whether they be rechargeable or not, fuel cells or capacitors.

In this respect, in another form of the present invention, the receiving port of a shutter assembly may be adapted so as to be capable of recharging the portable power supply in the portable power supply assembly. This may be achieved in a number of ways, such as by the receiving port being electrically connected either directly or indirectly to a mains power supply that may be switched on and off for recharging as necessary, or by the receiving port being electrically connected either directly or indirectly to a low voltage transformer also capable of recharging the portable power supply.

Indeed, in one form, the receiving port will include both mechanical and electrical recharging connections that allow an external recharging source to be connected thereto when the portable power supply assembly is also connected thereto, such that any batteries in the portable power supply assembly are recharged in use.

Furthermore, it will be appreciated that while the portable power supply assembly need not contain any extraneous electronics (extraneous to its fundamental operation in supplying power) it may incorporate other such electronics, such as current sensing electronics and/or battery charging electronics, as well as providing for a variety of different types of switchings that both raise and lower the shutter as well as switch off the electrical motor at some intermediate point.

It will thus be appreciated that shutter assemblies utilizing the portable power supply assembly of the present invention do not have an essential need to be individually wired to a power source, such as a mains power supply. The shutter assemblies need only be wired to a receiving port so that suitable power may be received therethrough. This is particularly advantageous where a number of shutter assemblies are installed in one building as 240 volt wiring is not required to each shutter assembly.

Also, where a number of roller shutter assemblies are installed for the windows of a single dwelling, the owner of the dwelling need only have a single portable power supply assembly that can be used to operate each shutter assembly.

Alternatively, the shutter assemblies may each be electrically interconnected such that they are provided with only a single receiving port to be operated by a single portable power supply assembly, which is advantageous for many reasons, including ease of operation and safety. For instance, in the event of a fire (perhaps where mains power to the dwelling has been cut), closed shutters can all be quickly opened at once. Also, for large openings, such as bay windows, that may contain a number of separate shutters to be fully enclosed, it will of course be required to have the operation of all of these shutters synchronized to ensure uniform opening of the entire window.

However, it will of course be appreciated by a skilled addressee that the addition of extra shutter assemblies for operation by a single portable power supply assembly will likely result in the electrical design of the portable power supply assembly being adapted to satisfy different power and current sensing requirements.

Additionally, by utilizing a system where the power supply is detachable, the shutter assemblies themselves may be rendered inoperable when the power supply assembly is detached, which provides added security and safety.

Finally, it will be appreciated that the use of such a portable power supply assembly allows for easy retro-fit of an electric motor drive unit to an existing mechanically operated shutter assembly. Indeed, as there is no need to hardwire the shutter assembly to a source of mains power, the retro-fit becomes essentially a mechanical retro-fit able to be attended to almost entirely external of the dwelling, with the obvious exception of the wall mounted receiving port which would ordinarily be located inside the dwelling.

In addition to the use of a portable power supply assembly, this patent specification also describes and defines the use of a torsion spring assembly with shutter assemblies of the type described above, with a view to assisting to reduce or minimize the load on the electric motors.

Thus, the present invention provides a torsion spring assembly capable of reducing load on the electric motor of a shutter assembly, the shutter assembly including a flexible shutter able to open and close by being wound onto and off a rotating shaft, wherein the torsion spring assembly includes:

(a) a housing able to be mounted at or towards one end of the shaft;

(b) a torsion spring mounted within the housing, one end of the torsion spring being held with respect to the housing; and

(c) a shaft adapter rotatably mounted with respect to the housing, the other end of the torsion spring being held with respect to the shaft adapter, the shaft adapter capable of being connected to the shaft so that the torsion spring is loaded as the shaft adapter is rotated by the shaft when the flexible shutter is wound off the shaft.

The present invention also provides a shutter assembly having a torsion spring assembly, the shutter assembly including an electric motor and a flexible shutter able to open and close by being wound onto and off a rotating shaft, the torsion spring assembly including:

(a) a housing able to be mounted at or towards one end of the shaft;

(b) a torsion spring mounted within the housing, one end of the torsion spring being held with respect to the housing; and

(c) a shaft adapter rotatably mounted with respect to the housing, the other end of the torsion spring being held with respect to the shaft adapter, the shaft adapter being connected to the shaft so that the torsion spring is loaded as the shaft adapter is rotated by the shaft when the flexible shutter is wound off the shaft.

In a preferred form, the shutter assembly is configured such that the flexible shutter is constrained by guide rails arranged along at least the sides of the periphery of an opening, to provide a substantially vertical shutter when closed. This would be the normal configuration where the opening was a door or a window. Thus, in use, as the flexible shutter is wound off the rotating shaft in operation (to close the opening) the bulk of the shutter essentially moves downwardly increasing the load (due to gravity) on the electric motor.

However, in this form of the invention, at the same time, the torsion spring is loaded, which naturally urges the shutter upwardly, providing resistance to the downward load of the shutter. This reduces the load on, and the work requirements of, the electric motor when the shutter assembly next operates to raise the shutter.

As a result, smaller electric motors may be utilized, providing significant flexibility in design and construction. Indeed, the use of a torsion spring assembly of this type has been found to permit the use of smaller than usual electric motors that may then be included in a drive unit located either external (and thus not within) the rotating shaft of the shutter assembly, or be within that rotating shaft, such as would be the case with a traditional tube drive unit of this type.

In this respect, a drive unit located externally of the rotating shaft may advantageously be located at one end of the rotating shaft, namely at the end opposite to the end at which the torsion spring assembly is mounted. This gives rise to benefits in terms of ease and flexibility in design in both the electrical and mechanical areas for shutter assemblies of the type that this invention relates to.

Further with respect to this form of the invention, the housing of the torsion spring assembly may include a pair of spaced apart plates such that the torsion spring may be a spiral spring located between the plates. Such a spiral spring may be wound of flat strip in a spiral form, typically with adjacent coils touching, and is often referred to as a power spring, a motor spring, or a clock spring.

Preferably, one end of the torsion spring (in this form, the radially outer end) terminates with a retaining portion that locates on an abutment extending between the two plates. The other end of the torsion spring (in this form, the radially innermost end) may then also terminate with a similar retaining portion associated with a part of the shaft adapter that extends through the housing. Either or both retaining portions may simply be a hook configuration provided at the respective ends of the spring.

In this form, the shaft adapter is able to rotate with respect to the housing, but this rotation is resisted by the action of the torsion spring. The shaft adapter is preferably configured such that it engages with the rotating shaft of the shutter assembly in a suitable manner that gives rise to the transfer of torque therebetween, such as by way of a splined outer surface that engages with a splined inner surface within one end of the shaft. However, it will be appreciated that other connections such as pinning, threaded fasteners or riveting may also be used.

Alternatively, a pair of formed sheet metal components may be used to sandwich a torsion spring and a linking member between them, the linking member itself being rigidly securable to the shaft adaptor. In this form, the outer end of the torsion spring may be provided with a hook that locates in a slot provided on the plates, while the inner end may be provided with a hook that engages on the linking member. The linking member then preferably contains splines on its inner face which are designed to engage with similar splines on an end of the shaft adaptor.

Additionally, a shutter assembly utilizing this torsion spring assembly may include an anti-backdrive feature. In this respect, when the shutter is in the fully down position, the rotating shaft no longer carries the shutter weight (namely, the shutter is free-standing), but the drive unit is bearing the full torque of the torsion spring. It is thus important that the shutter is locked in position when power to the drive unit is off, and that this torque not cause the drive unit to backdrive, causing the shutter to rise. This is particularly the case for large or heavy shutters, where the loaded torque will be significant.

Such anti-backdrive features may be accomplished by changes to the gearing in the drive unit, but these changes tend to lead to reduced gearbox output torque. An alternative is to incorporate a separate lock that prevents rotation of the gearbox output shaft when the motor power is off and the shutter is in the fully down position.

Thus, in one form, the shutter assembly may be provided with an electrically-actuated brake in the drive unit, where the brake is applied in the power-off state using a spring. The brake may be released using a solenoid acting on the brake.

In another form, the shutter assembly may be provided with a component between the gearbox output shaft and the axle. When the shutter is in the down position, torque from the clockspring that would normally cause backdriving is reacted by the mechanical lock that becomes engaged when the shutter is fully down. No torque is fed from the spring to the gearbox output shaft and thus backdriving cannot occur.

### BRIEF DESCRIPTION OF THE DRAWINGS

Several preferred embodiments of the present invention will now be described in relation to the accompanying drawings. However, it is to be appreciated that the invention is not to be limited only to these embodiments.

In the drawings:

FIG. 1 is a perspective view of a shutter assembly;

FIGS. 2a and 2b are perspective views of a portable power supply assembly in accordance with the present invention;

FIGS. 3a and 3b are perspective views of another portable power supply assembly in accordance with the present invention;

FIGS. 4a and 4b are perspective assembled and disassembled views of a torsion spring assembly in accordance with the present invention; and

FIG. 5 is a perspective disassembled view of a torsion spring assembly in accordance with the present invention.

### DETAILED DESCRIPTION OF THE PREFERRED EMBODIMENTS

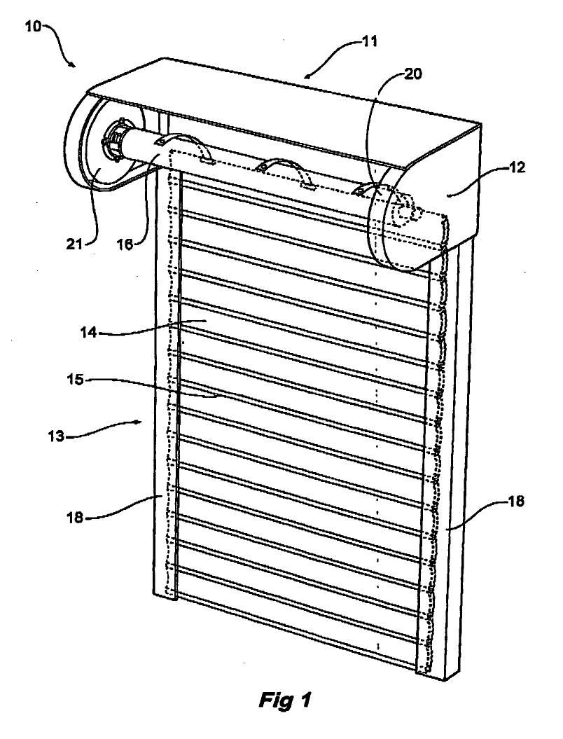

Referring to FIG. 1, the shutter assembly comprises a head box 10 which itself comprises a top cover 11 and end plates 12. A shutter 13 comprises a plurality of slats 14 that are connected to one another by hinges 15 that are formed in each adjacent edge of the slats 14. In this respect, it will of course be appreciated that the presence of a head box is not essential. Indeed, in many installations, the head box will be replaced by an enclosure of some sort built in to a cavity or the like on-site.

Returning to the embodiment illustrated, the shutter 13 is attached to a shaft 16 that is rotatably mounted within the head box 10. The hinges 15 result in the shutter 13 being flexible so that it can be wound onto and off the shaft 16. Guide rails 18 comprise U-shaped channels within which the edges of the shutter 13 locate so that the shutter 13 is deployed in a planar form when it is wound from the shaft 16, typically in a vertical configuration as shown.

The shutter assembly is provided with a suitable drive unit 20 powered by an electric motor. The drive unit 20 is shown located at an end of the shaft 16, although it should be appreciated that in some embodiments of the present invention, the motor may be such as a traditional tube motor located within the shaft 16.

The shutter assembly also comprises a torsion spring assembly 21 that is connected to the shaft at the end opposite to where the drive unit 20 is located. The shaft 16 is rotatably mounted between both the drive unit 20 and the torsion spring assembly 21. Both the drive unit 20 and the torsion spring assembly 21 are secured to the end plates 12 via suitable means.

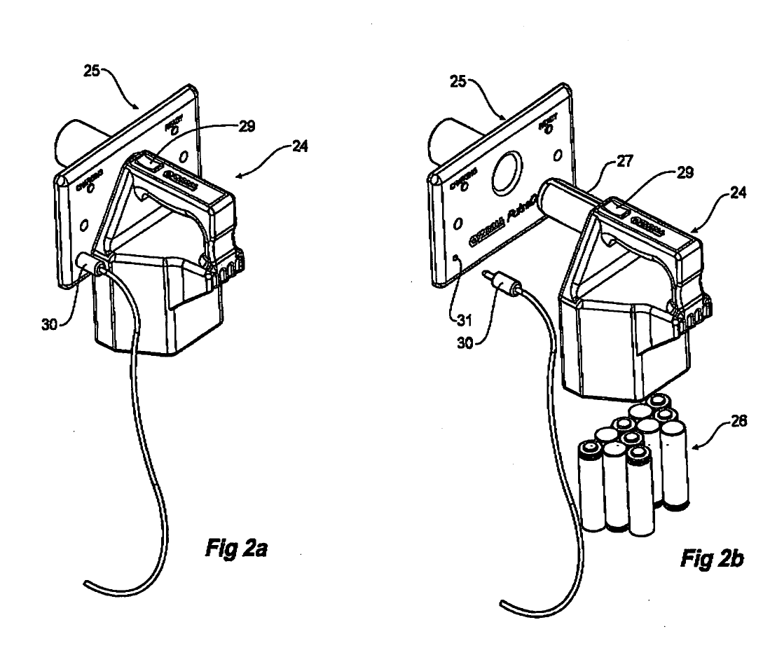

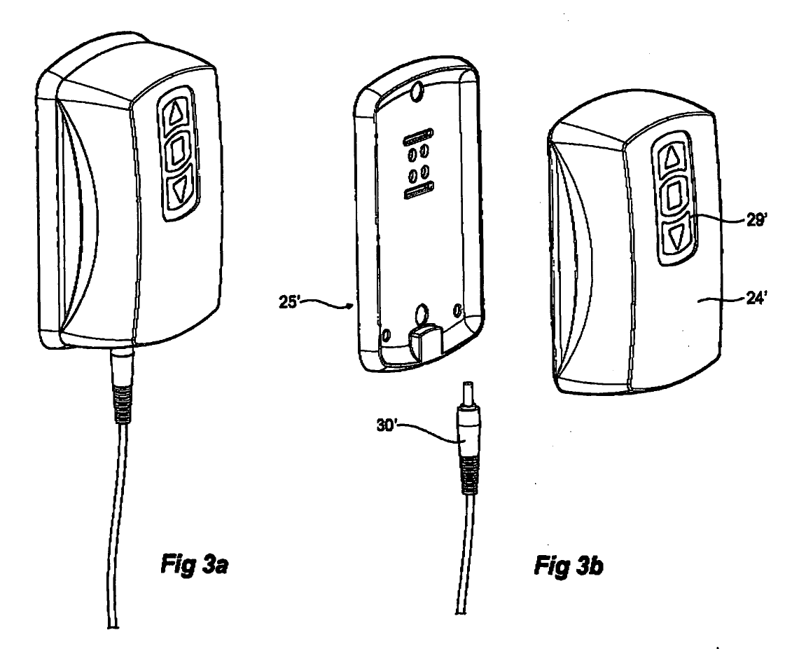

FIGS. 2a and 2b show a portable power supply assembly that is used to power the drive unit 20 that drives the shutter 13 up and down. Additionally, a second embodiment of a power supply assembly is shown in FIGS. 3a and 3b. Separate reference will not be made to FIGS. 3a and 3b, but like parts (where shown) will be referenced by the use of prime reference numerals.

The power supply assembly of FIGS. 2a and 2b comprises a hand held body 24 that is capable of electrically connecting a portable supply of power (namely, rechargeable batteries 26) to an electrical power receiving port (namely, the wall mounted plate 25). The body 24 houses the rechargeable batteries 26 and has a plug 27 that locates into a socket 28 within the plate 25 to provide both the mechanical and electrical connection required. The socket 28 is wired directly to the electric motor contained within the drive unit 20.

The body 24 is provided with a controlling means, such as a switching means in the form of a momentary contact push button switch 29 that is used to control the direction of travel of the shutter 13, ordinarily in response to input from a user request. The switch 29 has a central off position with an up and down position either side. After the plug 27 is connected to the socket 28, the switch 29 may then be activated as appropriate by the user to activated to raise or lower the shutter 13 as required. The shutter 13 may also of course be stopped at any intermediate position between its lowermost and uppermost positions by moving the switch 29 to the off position.

The body 24 may also contain circuitry that utilizes current sensing to sense the end of travel of the shutter 13 in its up and down positions. Such circuitry may also be capable of interpreting button positions and any particular time, and reacting to that accordingly, and may also be able to control the re-charging of the battery pack.

The batteries 26 may be recharged via the wall mounted plate 25. In this form, a lead from the charger unit 30 plugs into a socket 31 in the plate 25 which is connected to the plug 27 to enable recharging of the batteries 26. The charger unit which is attached to the lead 30 is plugged into a mains power supply in a conventional manner. Alternatively, and as is apparent from the embodiment in FIGS. 3a and 3b, the lead from the charger unit 30′ may connect directly to the body 24′ to enable recharging.

In use, a separate plate 25 will usually be installed for each shutter assembly. The hand held body 24 is a convenient means of providing a single power source that can be used for each separate shutter assembly. It means that each shutter assembly does not need to be hard wired to a 240 volt power supply, which also means that the wiring can be installed without the need for an electrical tradesperson.

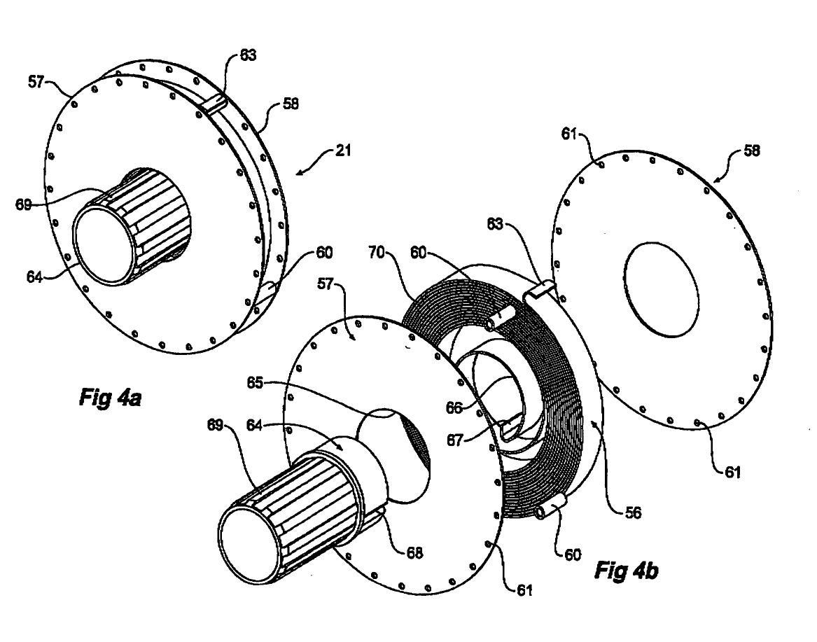

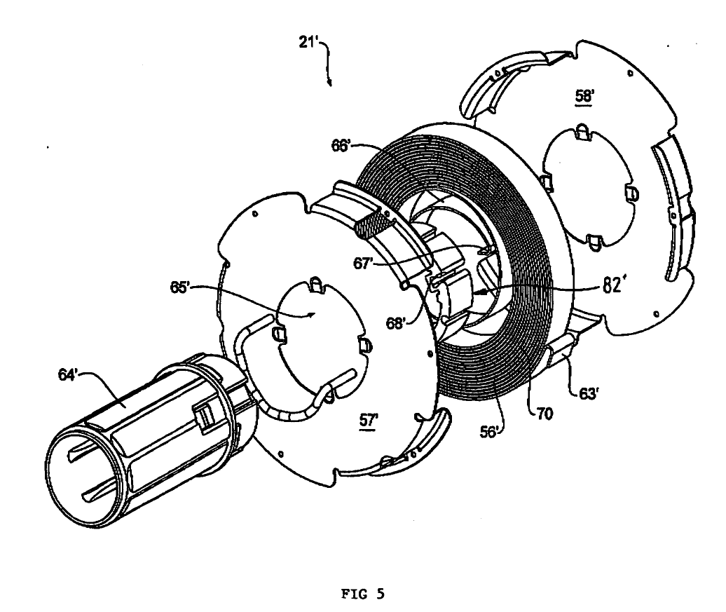

FIGS. 4a and 4b show the torsion spring assembly 21. Again, FIG. 5 shows a second embodiment of a torsion spring assembly 21, where like parts (where shown) are illustrated with prime reference numerals.

The torsion spring assembly 21 in FIGS. 4a and 4b includes a torsion spring 56 that is held captive between retaining plates 57 and 58 that together define a housing. The retaining plates 57, 58 are held apart by dowels 60 where the ends of the dowels 60 locate within apertures 61 within the retaining plates 57, 58. The ends of the dowels 60 are peened over to thereby hold the plates 57, 58 with respect to the dowels 60.

The torsion spring 56 at a first end terminates with a hook configuration in the form of a first end loop 63 that latches over one of the dowels 60. This end is thus fixed relative to the housing.

A shaft adapter 64 locates through an aperture 65 within retaining plate 57. The shaft adapter 64 locates within an inner loop 66 of the torsion spring 56. The inner loop 66 itself terminates with a hook configuration in the form of a second end loop 67 that engages within a slot 68 in the shaft adapter 64.

The retaining plate 58 also has an aperture (not shown) similar to aperture 65 in the retaining plate 57. The shaft adapter 64 has a roller bearing located in its end (the end opposite the spline portion of the shaft adapter 64) that engages a bearing boss formed in the end plate 12. In conjunction with the roller bearing located within the drive plate 44, the bearing in the shaft adapter 64 rotatably supports the shaft adapter 64 between the two end plates 12. The shaft adapter 64 also has a spline portion 69 that locates within the shaft 16.

In the alternative embodiment illustrated in FIG. 5, alterations have been made to assist with various interactions. For instance, a pre-loading pin 80′ has been introduced to engage with a linking member in the form of a collar 82′ for assisting with providing the torsion spring 70′ in a pre-loaded state at installation, and in providing a more uniform surface for the shaft adapter 64′ to engage with which also assists with location.

For both embodiments, rotation of the shaft adapter 64 causes the inner loop 66 to be rotated with respect to the coiled portion 70 of the torsion spring 56. When loaded, the torsion spring 56 is wrapped around the inner loop 66. The coiled portion 70 of the torsion spring 56 has sufficient travel to allow the shutter 13 to be fully lowered.

The loaded torsion spring assembly 21 assists upward movement of the shutter 13. From its fully down position, the torsion spring assembly 21 provides sufficient force to ensure that minimal power is required to raise the shutter 13 from its fully down position. Obviously this load remains in balance as the torsion spring 56 is unwound and the suspended weight of the shutter 13 reduces. As such, a minimum load requirement is maintained throughout the upward movement of the shutter 13. In this respect, it will also be appreciated that the torsion spring will be at or close to fully unloaded when the shutter is fully up.

As mentioned earlier, the use of such a torsion spring assembly readily allows the use of an electric motor with shutter assemblies of the type described in this specification. Indeed, electric motors of lower power than normal may be used due to the reduction in load requirements brought about by the loading of the torsion spring.

In this respect, it is envisaged that existing shutter assemblies will be able to be easily retrofitted with such a torsion spring assembly at one end of the existing rotating shaft, which allows the use of an electric powered drive unit at the other end, which in turn allows the use of (and operation with) the portable power supply assembly described earlier.

Finally, it will be appreciated that there may be other variations and modifications that are also within the scope of the matters described above.

1. A portable power supply assembly capable of providing electrical power to an electric motor of a shutter assembly, the shutter assembly including a flexible shutter able to open and close by being wound onto and off a rotating shaft, and an electrical power receiving port electrically connected to the electric motor, wherein the portable power supply assembly includes:
(a) a portable supply of power;
(b) a detachable body capable of electrically connecting the portable supply of power to the receiving port; and
(c) a means for switching on an off the portable supply of power to operate the shutter assembly when the detachable body is connected to the receiving port.

2. A portable power supply assembly according to claim 1, wherein the electrical power receiving port is near or adjacent the flexible shutter.

3. A portable power supply assembly according to claim or claim 2 wherein the port is a wall-mounted plate electrically connected directly or indirectly to the electric motor.

4. A portable power supply assembly according to claim 3 wherein the plate is adapted so as to both mechanically and electrically receive the detachable body.

5. A portable power supply assembly according to claims 1, wherein the portable power supply is batteries, whether they be rechargeable or not, a fuel cell or a capacitor.

6. A portable power supply assembly according to claims 1, wherein the receiving port is adapted so as to be capable of recharging the portable power supply.

7. A shutter assembly having a portable power supply assembly, the shutter assembly including an electric motor, an electrical power receiving port electrically connected to the electric motor, and a flexible shutter able to open and close by being wound onto and off a rotating shaft, the portable power supply assembly including:
(a) a portable supply of power;
(b) a detachable body capable of electrically connecting the portable supply of power to the receiving port; and
(c) a means for switching on and off the portable supply of power to operate the shutter assembly when the detachable body is connected to the receiving port.

8. A series of shutter assemblies and a single portable power supply assembly, each shutter assembly including an electric motor, an electrical power receiving port electrically connected to the electric motor, and a flexible shutter able to open and close by being wound onto and off a rotating shaft, the single portable power supply assembly including:
(a) a portable supply of power;
(b) a detachable body capable of electrically connecting the portable supply of power to any of the receiving ports; and
(c) a means for switching on and off the portable supply of power to operate a shutter assembly when the detachable body is connected to the receiving port of that shutter assembly.

9. A series of shutter assemblies according to claim 8 wherein the series includes a single electrical power receiving port electrically connected either directly or indirectly to the electric motor of each shutter assembly.

10. A torsion spring assembly capable of reducing load on the electric motor of a shutter assembly, the shutter assembly including a flexible shutter able to open and close by being wound onto and off a rotating shaft, wherein the torsion spring assembly includes:
(a) a housing able to be mounted at or towards one end of the shaft;
(b) a torsion spring mounted within the housing, one end of the torsion spring being held with respect to the housing; and
(c) a shaft adapter rotatably mounted with respect to the housing, the other end of the torsion spring being held with respect to the shat adapter, the shaft adapter capable of being connected to the shaft so that the torsion spring is loaded as the shaft adapted is rotated by the shaft when the flexible shutter is wound off the shaft.

11. A torsion spring assembly according to claim 10, wherein the housing is a part of a built-in enclosure in a wall cavity or the like.

12. A torsion spring assembly according to claim 10, wherein the housing includes a pair of spaced apart plates such that the torsion spring may be a spiral torsion spring located between the plates.

13. A torsion spring assembly according to claim 12, wherein one end of the torsion spring (the radially outer end) terminates with a retaining portion that locates on an abutment.

14. A torsion spring assembly according to claim 13, wherein the other end of the torsion spring (the radially innermost end) terminates with a retaining portion that locates on the shaft adapter.

15. A torsion spring assembly according to claims 10, wherein the shaft adapter is configured such that it engages with the rotating shaft in a manner suitable to transfer torque therebetween.

16. A torsion spring assembly according to claim 15 wherein the shaft adapter is configured such that it engages with the rotating shaft by way of a splined outer surface that engages with a splined inner surface within one end of the shaft.

17. A shutter assembly having a torsion spring assembly, the shutter assembly including an electric motor and a flexible shutter able to open and close by being wound onto and off a rotating shaft, the torsion spring assembly including:
(a) a housing able to be mounted at or towards one end of the shaft;
(b) a torsion spring mounted within the housing, one end of the torsion spring being held with respect to the housing; and
(c) a shaft adapter rotatably mounted with respect to the housing, the other end of the torsion spring being held with respect to the shaft adapter, the shaft adapter being connected to the shaft so that the torsion spring is loaded as the axle is rotated by the shaft when the flexible shutter is wound off the shaft.

18. A shutter assembly having a portable power supply assembly and a torsion spring assembly, the shutter assembly including an electric motor, an electric power receiving port electrically connected to the electric motor, and a flexible shutter able to open and close by being wound onto and off a rotating shaft, the portable power supply assembly being capable of providing electrical power to the electric motor, the portable power supply assembly including:
(a) a portable supply of power;
(b) a detachable body capable of electrically connecting the portable supply of power to the receiving port; and
(c) a means for switching on and off the portable supply of power to operate the shutter assembly when the detachable body is connected to the receiving port;
the torsion spring assembly being capable of reducing load on the electric motor, the torsion spring assembly including;
(d) a housing able to be mounted at or towards one end of the shaft;
(e) a torsion spring mounted with the housing, one end of the torsion spring being held with respect to the housing; and
(f) a shaft adapter rotatably mounted with respect to the housing, the other end of the torsion spring being held with respect to the shaft adapter, the shaft adapter capable of being connected to the shaft so that the torsion spring is loaded as the shaft adapter is rotated by the shaft when the flexible shutter is wound off the shaft.

19. A portable power supply assembly according to claim 1 substantially as herein described in relation to FIGS. 2a, 2b, 3a and 3b.

20. A torsion spring assembly according to claim 10 substantially as herein described in relation to FIGS. 4a, 4b and 5.

21. A shutter assembly according to claims 7, substantially as herein described in relation to the accompanying drawings.
